(19) United States
(12) Patent Application Publication
(10) Pub. No.: US 2018/0194465 A1
(43) Pub. Date: Jul. 12, 2018

(54) SYSTEM AND METHOD FOR VIDEO BROADCASTING

(71) Applicant: SZ DJI TECHNOLOGY CO., LTD., Shenzhen (CN)

(72) Inventors: Weifeng LIU, Shenzhen (CN); Chuyue AI, Shenzhen (CN)

(21) Appl. No.: 15/912,025

(22) Filed: Mar. 5, 2018

Related U.S. Application Data
(63) Continuation of application No. PCT/CN2015/090749, filed on Sep. 25, 2015.

(51) Int. Cl. B64C 39/02; H04L 29/06

(52) U.S. Cl. CPC B64C 39/024; H04L 29/06517; B64C 2201/127; H04L 65/607; H04L 65/4076

(57) ABSTRACT

A system for video broadcasting includes a plurality of mobile nodes configured to capture one or more pictures and exchange control signals among the plurality of mobile nodes, and a terminal node configured to receive the one or more pictures from the plurality of mobile nodes and upload the one or more pictures to a video server.

### CROSS-REFERENCE TO RELATED APPLICATION

This application is a continuation application of International Application No. PCT/CN2015/090749, filed on Sep. 25, 2015, the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD

The disclosed embodiments relate generally to video broadcasting and more particularly, but not exclusively, to systems and methods for supporting video broadcasting from one or more mobile platforms.

### BACKGROUND

Traditional aerial imaging systems lack a capacity to broadcast captured pictures in a real-time manner. The pictures captured by such aerial imaging systems are usually presented in a time-delayed manner via a storage device of some sort. This delay sometimes affects an entertaining effect and/or a news propagation speed of the captured pictures.

In view of the foregoing reasons, there is a need for a system and method to broadcast, via the Internet, pictures captured with an aerial imaging system in a real-time manner.

### SUMMARY

In accordance with a first aspect disclosed herein, there is set forth a system for video broadcasting, comprising:

one or more mobile nodes, each the mobile node operates to capture one or more pictures; and

a terminal node that operates to upload the captured pictures from the mobile nodes to a video server.

In an exemplary embodiment of the disclosed systems, mobile nodes are associated with a plurality of mobile platforms.

In another exemplary embodiment of the disclosed systems, each of the mobile nodes is associated with a respective mobile platform.

In another exemplary embodiment of the disclosed systems, the terminal node receives the captured pictures from the mobile nodes.

In another exemplary embodiment of the disclosed systems, the video server is accessible via one or more client receivers.

In another exemplary embodiment of the disclosed systems, at least one of the mobile nodes is an aerial node.

In another exemplary embodiment of the disclosed systems, the mobile nodes exchange control signals via a peer-to-peer protocol.

In another exemplary embodiment of the disclosed systems, at least one of the mobile nodes is configured to collect a first audio signal.

Exemplary embodiments of the disclosed systems further comprise a control node that operates to coordinate the mobile nodes and/or the terminal node.

In another exemplary embodiment of the disclosed systems, the control node is associated with at least one of the mobile nodes and the terminal node.

In another exemplary embodiment of the disclosed systems, at least one of the terminal node and the client receivers is enabled to control the mobile nodes.

In another exemplary embodiment of the disclosed systems, the terminal node is associated with a ground node or an aerial node.

In another exemplary embodiment of the disclosed systems, the mobile nodes are configured to transmit the captured pictures to the terminal node as a first bitstream.

In another exemplary embodiment of the disclosed systems, the terminal node is configured to receive the first bitstream from the mobile nodes via a datalink.

In another exemplary embodiment of the disclosed systems, the terminal node operates to upload the captured pictures to the video server as a second bitstream.

In another exemplary embodiment of the disclosed systems, the video server operates to receive the second bitstream for broadcasting the captured pictures.

In another exemplary embodiment of the disclosed systems, each of the mobile nodes comprises at least one imaging device that operates to capture the pictures.

In another exemplary embodiment of the disclosed systems, each of the mobile nodes is configured to encode the captured pictures to generate the first bitstream.

In another exemplary embodiment of the disclosed systems, the captured pictures are encoded in accordance with a private protocol.

In another exemplary embodiment of the disclosed systems, the captured pictures are encoded on or before being transmitted to the terminal node.

Exemplary embodiments of the disclosed systems further comprise a datalink configured to transmit the first bitstream from a selected mobile node to the terminal node.

In another exemplary embodiment of the disclosed systems, the mobile node is an unmanned aerial vehicle (“UAV”).

In another exemplary embodiment of the disclosed systems, the terminal node is a mobile device.

In another exemplary embodiment of the disclosed systems, the mobile device is at least one of a laptop, a desktop, a tablet and a mobile phone.

In another exemplary embodiment of the disclosed systems, the terminal node comprises an audio device that operates to capture a second audio signal.

In another exemplary embodiment of the disclosed systems, the audio device is a microphone.

In another exemplary embodiment of the disclosed systems, the terminal node further comprises an audio mixer that operates to merge the second audio signal with the captured pictures.

In another exemplary embodiment of the disclosed systems, the terminal node is configured to pack the captured pictures in accordance with a public protocol to generate the second bitstream for transmission to the video server.

In another exemplary embodiment of the disclosed systems, the terminal node transmits the second bitstream to the video server via the Internet.

In another exemplary embodiment of the disclosed systems, the public protocol includes at least one of a Real Time Messaging Protocol (“RTMP”) protocol and a Real Time Streaming Protocol (“RTSP”) protocol.

In another exemplary embodiment of the disclosed systems, the video server is provided by a web service provider.

In another exemplary embodiment of the disclosed systems, the mobile nodes capture the pictures from a plurality of view-angles and/or elevations.

In another exemplary embodiment of the disclosed systems, the client receivers have access to each of the video servers for displaying the captured pictures.

In another exemplary embodiment of the disclosed systems, the client receivers access the video server via the Internet.

In accordance with another aspect disclosed herein, there is set forth a method for video broadcasting, comprising:

receiving one or more pictures captured by one or more mobile nodes by a terminal node; and

uploading the captured pictures from the terminal node to a video server accessible from a plurality of client receivers.

Exemplary embodiments of the disclosed methods further comprise capturing the pictures with the mobile nodes.

In another exemplary embodiment of the disclosed methods, capturing the pictures comprises capturing the pictures with the mobile nodes associated with respective mobile platforms.

In another exemplary embodiment of the disclosed methods, capturing pictures with one or more mobile nodes comprises capturing pictures with one or more aerial nodes.

Exemplary embodiments of the disclosed methods further comprise communicating control signals among the mobile nodes in accordance with a peer-to-peer protocol.

In another exemplary embodiment of the disclosed methods, capturing the pictures comprises collecting a first audio signal with at least one mobile node.

Exemplary embodiments of the disclosed methods further comprise coordinating the mobile nodes and/or the terminal node with a control node.

In another exemplary embodiment of the disclosed methods, the control node is associated with at least one of the mobile nodes and the terminal node.

Exemplary embodiments of the disclosed methods further comprise enabling at least one of the terminal node and the client receivers to control the mobile nodes.

In another exemplary embodiment of the disclosed methods, uploading comprises uploading the captured pictures by the terminal node as a second bitstream.

Exemplary embodiments of the disclosed methods further comprise positioning the mobile nodes on one or more respective aerial platforms.

In another exemplary embodiment of the disclosed methods, uploading the second bitstream of the captured pictures comprising uploading the second bitstream to the Internet.

Exemplary embodiments of the disclosed methods further comprise encoding the pictures by the mobile node to generate the second bitstream.

In another exemplary embodiment of the disclosed methods, encoding the pictures comprises encoding the pictures in accordance with a private protocol.

Exemplary embodiments of the disclosed methods further comprise transmitting the first bitstream to the terminal node.

In another exemplary embodiment of the disclosed methods, transmitting the first bitstream comprises transmitting the first bitstream through a datalink.

In another exemplary embodiment of the disclosed methods, the mobile node is an Unmanned Aerial Vehicle (“UAV”).

In another exemplary embodiment of the disclosed methods, transmitting the first bitstream to the terminal node comprising transmitting the first bitstream to a mobile device.

In another exemplary embodiment of the disclosed methods, transmitting the first bitstream to a mobile device comprises transmitting the first bitstream to at least one of a computer and a mobile phone.

Exemplary embodiments of the disclosed methods further comprise capturing audio data via an audio device from the terminal node.

In another exemplary embodiment of the disclosed methods, capturing the audio data via an audio device comprises capturing the audio data via a microphone.

Exemplary embodiments of the disclosed methods further comprise merging the audio data with the pictures.

Exemplary embodiments of the disclosed methods further comprise converting the second bitstream to a public protocol.

Exemplary embodiments of the disclosed methods further comprise transmitting the second bitstream to a video server via the Internet.

Exemplary embodiments of the disclosed methods further comprise transmitting the second bitstream by the terminal node to the video server via the Internet.

In another exemplary embodiment of the disclosed methods, converting the second bitstream to a public protocol comprises converting the second bitstream to at least one of a Real Time Messaging Protocol (“RTMP”) protocol and a Real Time Streaming Protocol (“RTSP”) protocol.

In another exemplary embodiment of the disclosed methods, capturing the pictures comprises capturing the pictures from a plurality of view-angles and/or elevations.

Exemplary embodiments of the disclosed methods further comprise comprising displaying the pictures.

In another exemplary embodiment of the disclosed methods, displaying the pictures comprises enabling the pictures accessible for the client receivers.

In accordance with another aspect disclosed herein, there is set forth a system for broadcasting videos being captured from one or more aerial platforms configured to perform the broadcasting process in accordance with any one of previous embodiments of the disclosed methods.

A computer program product comprising instructions for broadcasting videos being captured from one or more aerial platforms configured to perform the broadcasting process in accordance with any one of previous embodiments of the disclosed methods.

### BRIEF DESCRIPTION OF THE DRAWINGS

FIG. 1 is an exemplary top-level block diagram illustrating an embodiment of a video broadcasting system, wherein the video broadcasting system includes a mobile node, a terminal node and a video server.

FIG. 2 is an exemplary top-level flowchart illustrating an embodiment of a video broadcasting method, wherein pictures are captured and uploaded to the video server of FIG. 1.

FIG. 3 is an exemplary block diagram illustrating an alternative embodiment of the system of FIG. 1, wherein the mobile node includes an imaging device for capturing pictures.

FIG. 4 is an exemplary flowchart illustrating an alternative embodiment of the method of FIG. 2, wherein the captured pictures are streamed to the terminal node.

FIG. 5 is an exemplary detail diagram illustrating another alternative embodiment of the system of FIG. 1, wherein the system includes a plurality of the mobile nodes.

FIG. 6 is an exemplary block diagram illustrating another alternative embodiment of the system of FIG. 1, wherein the terminal node includes a microphone and a mixer for capturing audio signals.

FIG. 7 is an exemplary flowchart illustrating an embodiment of the method of FIG. 2 performed by the system of FIG. 6, wherein captured pictures are received by the terminal node and mixed with audio data.

FIG. 8 is an exemplary block diagram illustrating an embodiment of the system of FIG. 1, wherein the terminal node includes a control node for controlling the one or more mobile nodes.

FIG. 9 is an exemplary flowchart illustrating an embodiment of the method of FIG. 2 performed by the system of FIG. 8, wherein the mobile nodes are coordinated from a terminal node.

FIG. 10 is an exemplary block diagram illustrating an embodiment of the system of FIG. 1, wherein a video server has connections to a plurality of client receivers.

FIG. 11 is an exemplary flowchart illustrating an embodiment of the method of FIG. 2 performed by the system of FIG. 10, wherein a second bitstream of captured pictures is made accessible from a video server.

FIG. 12 is an exemplary block diagram illustrating an embodiment of the system of FIG. 1, wherein the captured pictures are transferred to a terminal node and then to a video server.

It should be noted that the figures are not drawn to scale and that elements of similar structures or functions are generally represented by like reference numerals for illustrative purposes throughout the figures. It also should be noted that the figures are only intended to facilitate the description of the embodiments. The figures do not illustrate every aspect of the described embodiments and do not limit the scope of the present disclosure.

### DETAILED DESCRIPTION OF THE EMBODIMENTS

In an aerial imaging system, pictures captured by an imaging device from a mobile platform, such as an Unmanned Aerial Vehicle (“UAV”), are stored in a storage device installed on the mobile platform for display at a later time.

In other aerial imaging systems, the captured pictures are transferred, via a datalink connection, to a ground device that saves the pictures in a storage device on the ground. The ground device can present the captured pictures at any time after receiving the pictures. The ground device, however, does not broadcast the pictures in real-time to client display devices.

In some other aerial imaging systems, Internet-based video servers can make the captured pictures available to viewers. The captured pictures are uploaded to the video servers in a time-delayed manner and thus are available for viewing only at a later time. Accordingly, currently-available aerial imaging systems are unable to broadcast the captured pictures in a real-time manner.

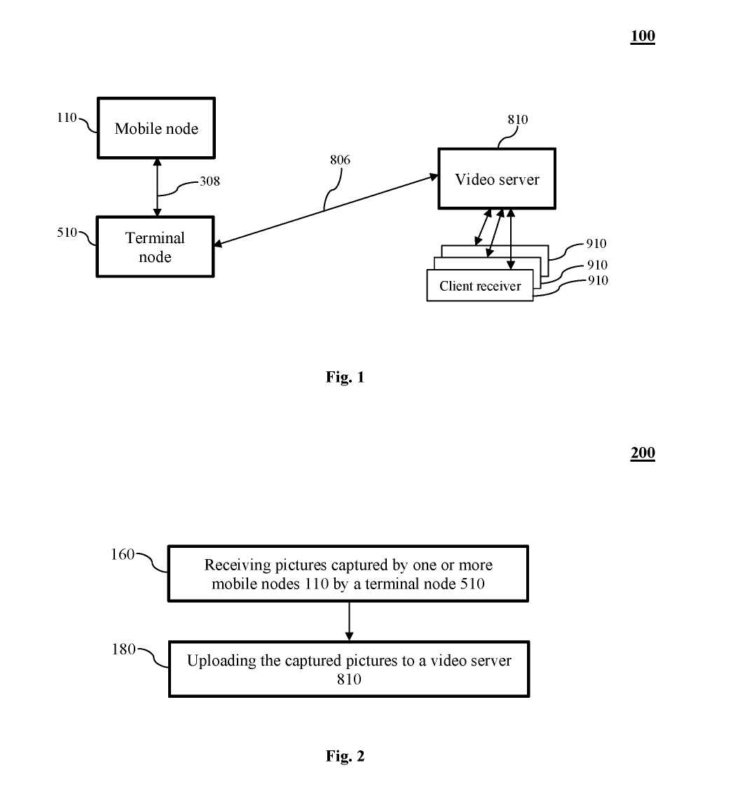

Since currently-available aerial imaging systems lack of means for broadcasting pictures captured from an aerial vehicle, a system and method that can transmit the captured pictures captured from the aerial vehicle to a video server and make the pictures enable client receivers associated with the Internet to view the motion pictures in a real-time manner can prove desirable. This result can be achieved, according to one embodiment illustrated in FIG. 1.

FIG. 1 shows an exemplary embodiment of a video broadcasting system 100, wherein the video broadcasting system 100 includes a mobile node 110, a terminal node 510 and a video server 810. In FIG. 1, the mobile node 110 can connect with the terminal node 510 via a first connection 308 that can be a wired and/or a wireless connection. The terminal node 510 can connect with the video server 810 via a second connection 806.

The mobile node 110 can capture pictures, including, but not limited to, still pictures, motion pictures and videos. The mobile node 110 can transfer (or transmit) the pictures to the terminal node 510 via the wired and/or wireless first connection 308. The transfer can allow the captured pictures to be presented at the terminal node 510 as the pictures are being captured. With the mobile node 110 and the transfer from the mobile node 110 to the terminal node 510, the mobile node 110 can acquire the captured pictures in a real-time manner.

The video broadcasting system 100 is shown and described with one mobile node 110 for purposes of illustration only and not for purposes of limitation. In the embodiments of the system 100, a plurality of mobile nodes 110 can be employed in a coordinated manner to capture the pictures.

The terminal node 510 can receive the captured pictures via the first connection 308 from the mobile node 110. At the terminal node 510, the captured pictures can be processed for certain purposes. Such purposes can include, but are not limited to, merging captured pictures, merging other data with the captured pictures and/or improving quality of the captured pictures. For example, audio data can be mixed with the captured pictures. Additional detail of the terminal node 510 will be shown and described below with reference to FIG. 6.

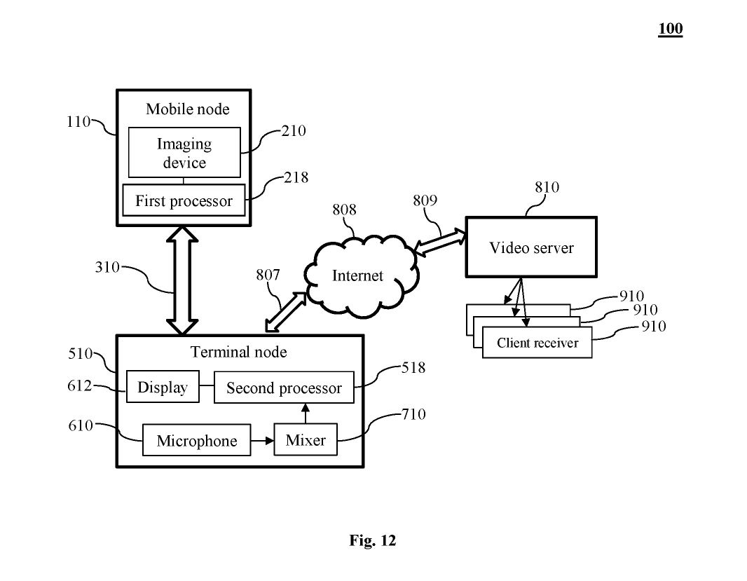

After being processed at the terminal node 510, the pictures can be transferred (or transmitted) to a video server 810 for purposes of distribution. The terminal node 510 can transfer the captured pictures in accordance with a public protocol that is acceptable to the video server 810. Additional detail regarding the transmission will be shown and described below with reference to FIGS. 6 and 12.

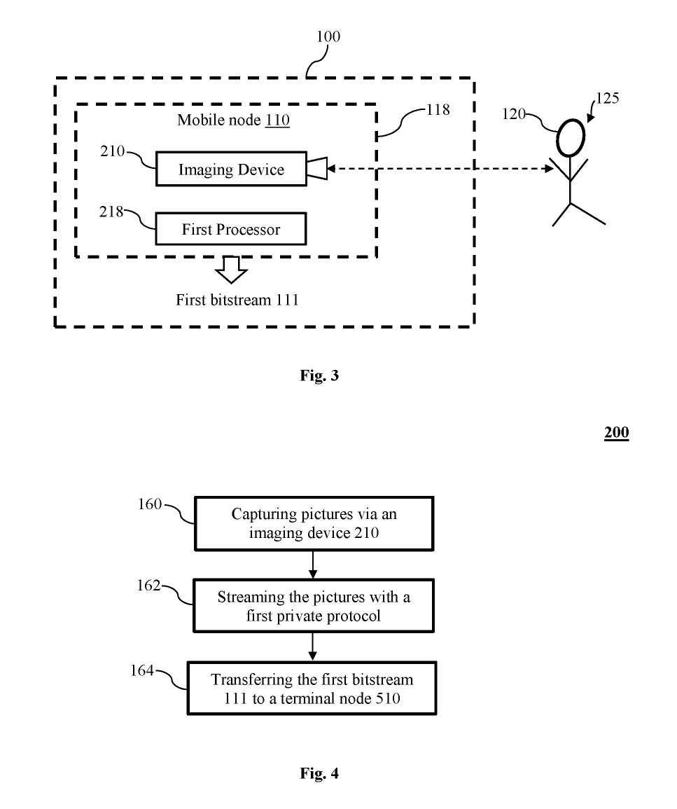

The video server 810 can receive the captured pictures from the terminal node 510 via the second connection 806. The video server 810 can notify or alert viewers with regard to availability of the captured pictures and make the pictures available to client receivers 910 (shown in FIG. 10) who are authorized to access the video server 810, via, e.g. a link (not shown). Additional detail regarding the video server 810 and accessibility of the pictures will be shown and described below with reference to FIG. 4.

Since the captured pictures can be transferred from the terminal node 510, while received, to the video server 810, the client receivers 910 can present the captured pictures as the pictures are received by the video server 810 in a real-time manner. Thereby, the system 100 can advantageously presents the pictures, captured by the mobile node 110, with the client receivers 910 in a real-time manner.

Although shown and described as using the video server 810 for purposes of illustrations only, other suitable web services that are accessible through the Internet can be used to broadcast the pictures captured by the mobile node 110.

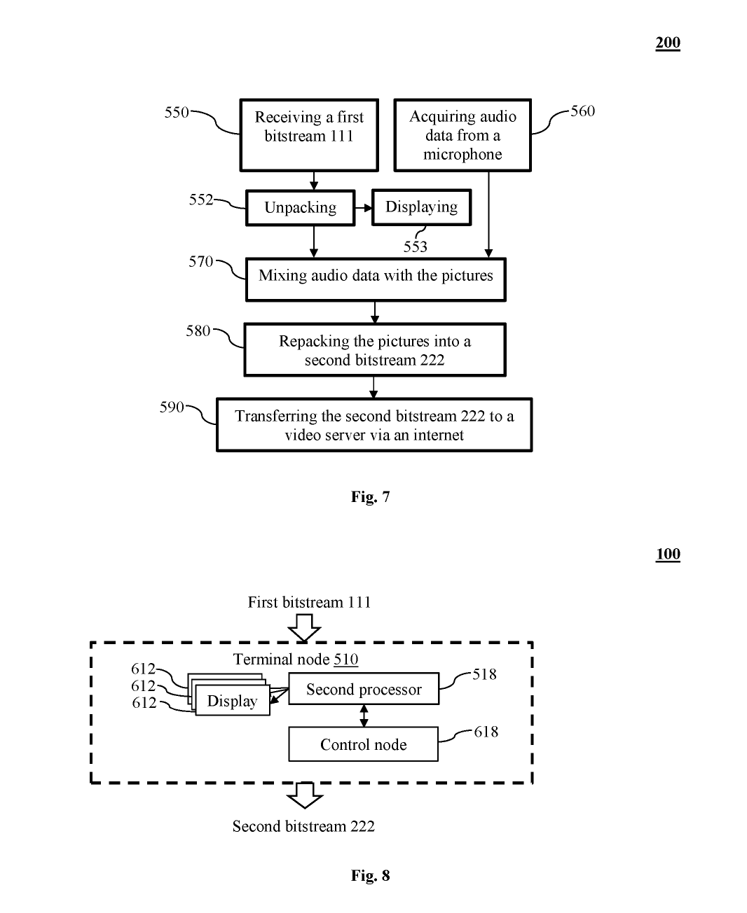

FIG. 2 illustrates an embodiment of a video broadcasting method 200. The method 200 enables pictures to be captured, transferred and uploaded to the video server 810 (shown in FIG. 1). In FIG. 2, the terminal node 510 can receive pictures captured and transferred from one or more mobile nodes 110, at 160. Details regarding capturing the pictures with the mobile nodes 110 will be discussed below with reference to FIGS. 3 and 4. The pictures can be transferred to the terminal node 510 via the first connection (shown in FIG. 1), that can be a datalink. At the terminal node 510, the captured pictures can be processed in manners as shown and described below with reference to FIGS. 6 and 7. In some embodiments, captions and/or audio data can be merged with the pictures.

The terminal node 510 can upload the pictures, at 180, to the video server 810. The pictures can be uploaded, at 180, in any conventional manner, such as via the Internet 808 (shown in FIG. 12) after being processed. In some embodiments, the pictures can be uploaded to a plurality of video servers 810.

The video server 810 can make the uploaded pictures accessible from the client receivers 910 (shown in 10). Thereby, the pictures captured from the one or more mobile nodes 110 can be transferred to the video server 810 and be presented to the client receivers 910 in a real-time manner. Detail regarding access the pictures will be discussed below with reference to FIGS. 10 and 11. The receiving and the uploading of the captured pictures can both be performed in a real-time manner. Thereby, the method 200 can enable the pictures captured by the mobile nodes 110 be broadcast to the client receivers 910 in a real-time manner.

FIG. 3 illustrates an alternative embodiment of the system 100. As shown in FIG. 3, the mobile node 110 includes an imaging device 210 for capturing the pictures. As described above with reference to FIG. 1, the mobile node 110 can be associated with a mobile platform 118. The mobile platform 118 can comprise, but are not limited to, a bicycle, automobile, truck, ship, boat, train, helicopter, aircraft, Unmanned Aerial Vehicle (“UAV”) or an Unmanned Aerial System (“UAS”), robot, various hybrids thereof, and the like. In case the mobile platform 118 is an aerial vehicle, the mobile node 110 can also be named as an aerial node. The aerial vehicle can be one of a helicopter, aircraft, UAV, UAS and any other platform that has no contact with the ground when being operated.

In FIG. 3, the imaging device 210 can be attached to the aerial platform 118. The imaging device 210, for example, can be a conventional camera system, such as a Red Green Blue (“RGB”) video camera with any suitable resolution capacity. The imaging device 210 can also be any other type of still cameras, motion picture cameras, digital cameras or film cameras including, but not limited to, a laser camera, an infrared camera, an ultrasound camera and the like. In some embodiments, the imaging device 210 can be positioned at a lower part of the mobile platform 118. In other embodiments, the imaging device 210 can be positioned at a side or any other suitable location of the mobile platform 118.

In some embodiments, the mobile node 110 can have an audio input device (not shown) for capturing audio data. For purposes of illustration and not for purposes of limitation, the audio input device can be a microphone associated with the imaging device 210 or the first processor 218. The audio input device can be used to capture on-site audio data while the imaging device 210 is capturing pictures.

In FIG. 3, the imaging device 210 is shown as being directed toward an object of interest 120 in a scene 125. In some embodiments, the imaging device 210 can be controllably positioned in any direction, including horizontally and/or vertically. The imaging device 210 can convert light signals reflected from the scene 125 into electrical data representing images of the scene 125. The imaging device 210 can transmit the electrical data to a first processor 218 that can be operably connected to the imaging device 210. The first processor 218 thereby can receive the electrical data from the imaging device 210, stream and/or segment the pictures to generate a first bitstream 111 for transmission. Additional detail regarding the transmission will be shown and discussed below with reference to FIG. 12.

Although shown and described as being one imaging device 210 for purposes of illustration only, the mobile platform 118 can include any preselected number of the imaging devices 210 for capturing the pictures.

Without limitation, the first processor 218 can include one or more general purpose microprocessors, for example, single or multi-core processors, application-specific integrated circuits, application-specific instruction-set processors, graphics processing units, physics processing units, digital signal processing units, coprocessors, network processing units, audio processing units, encryption processing units, and the like. The first processor 218 can be configured to perform any of the functions described herein, including but not limited to, a variety of operations relating to image processing. In some embodiments, the first processor 218 can include specialized hardware for processing specific operations relating to obstacle detection and avoidance—for example, processing time-of-flight data, processing ultrasound data, determining an obstacle distance based on collected data, and controlling the mobile platform 118 based on the determined distance.

FIG. 4 illustrates an alternative embodiment of the method 200. Turning to FIG. 4, pictures captured with the one or more mobile nodes 110 (shown in FIG. 1) are streamed, segmented and/or transferred to the terminal node 510 (shown in FIG. 1). The mobile node 110 can capture pictures, at 160. For example, the mobile node 110 can include an imaging device 210 for capturing pictures of a scene 125 in the manner shown and described herein with reference to FIG. 3. The captured pictures can be in a form of electric data representing the pictures.

At 162, the captured pictures can be streamed (and/or segmented) with a first protocol. The first protocol can be a proprietary protocol that is agreed by the mobile node 110 and a terminal node 510. The first protocol can be an only communication protocol running on both of the mobile node 110 and the terminal node 510. Alternatively, if the mobile node 110 and/or the terminal node 510 run a plurality of protocols, a negotiation between the mobile node 110 and the terminal node 510 can be conducted for selecting a proper protocol for the streaming the captured pictures into to a first bitstream 111.

At 164, the captured pictures can be transferred to the terminal node 510 in the form of the first bitstream 111. The transfer can be via a wired and/or wireless connection with any suitable transmission protocol. Additional detail regarding the packing and transferring will be discussed below with reference to FIG. 12.

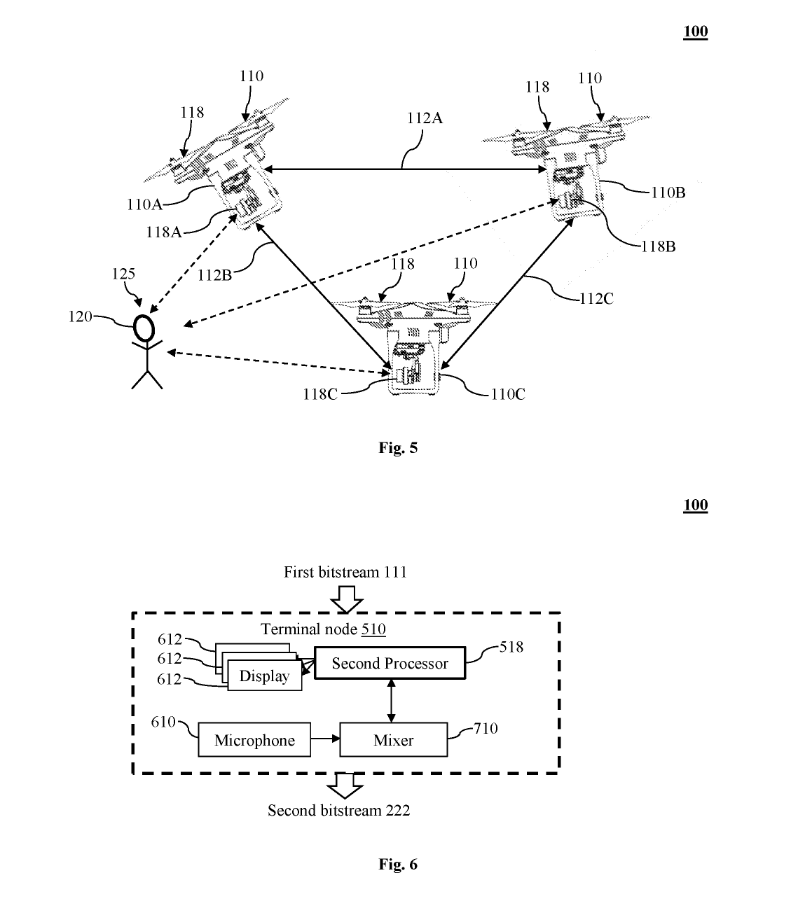

FIG. 5 shows another exemplary alternative embodiment of the system 100. Turning to FIG. 5, the system 100 includes a plurality of mobile nodes 110. Each of the mobile nodes 110 is enabled to communicate with at least one other mobile node 110. The mobile nodes 110 can communication in any suitable manner, including via wired and/or wireless connections, denoted as 112A, 112B, and 112C in FIG. 5. When connected with wireless connections, the mobile nodes 110 can operate under any suitable communication protocols, including, but not limited to, a suite of low power protocols, Zigbee, any fourth, fifth generation mobile networks and the like. Each of the protocols can be used to transfer control signals among the mobile nodes 110. Selection of the protocol can be based on certain requirements, including, but not limited to, distances among the mobile nodes 110, terrain features of an operating area, availability of cellular signal and even whether condition.

Optionally, a selected mobile node 110 can communicate with each of the other mobile nodes 110. The mobile nodes 110, for example, can communicate with each other for purposes of coordination. By being enabled to communicate, the mobile nodes 110 can cooperate to achieve a common goal, such as capturing pictures of a common scene 125 (shown in FIG. 3) from different perspectives.

In FIG. 5, three mobile nodes 118A-C are shown for capturing pictures of an object of interest 120 in a scene 125. The mobile nodes 118A-C can comprise, for example, three aerial nodes 110A, 110B and 110C and can be enabled to communicate with each other for capturing pictures of the scene 125. The aerial nodes 110A, 110B and 110C can also be other type of mobile nodes 110. The communication among the mobile nodes 110 can be in accordance with a peer-to-peer (“P2P”) protocol or any other protocols suitable for communication among the mobile nodes 110, including but not limited to the Zigbee protocols, the fourth generation protocols and the fifth generation protocols.

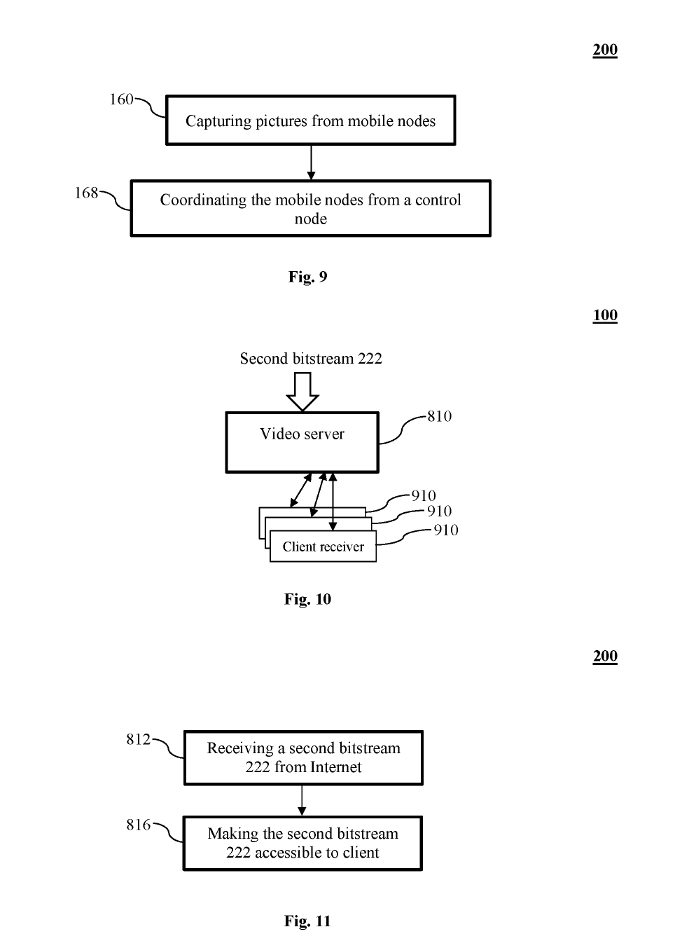

In some embodiments, at least one of the mobile nodes 110 can be configured, as a control node, to issue commands to other mobile nodes 110. The control node can be enabled to control at least one of the other mobile nodes 110 via the commands. Such control can include, but not limited to, synchronization of the mobile nodes 110 and/or coordination of each of the mobile nodes 110 to capture a complete view the object of interest 120. The coordination of the mobile nodes 110 can be conducted in a same manner shown and described with reference to FIG. 9. The commands can be generated from at the least one of the mobile nodes 110 based on a real situation of an object of interest 120 and/or the scene 125. Alternatively, the at least one of the mobile nodes 110 can receive commands and coordinate with other mobile nodes 110 based on the received commands. Each of the commands can be directed to at least one mobile node 110. At least one mobile node 110 is enabled to perform one or more actions in accordance to the commands issued from the mobile nodes 110 that are configured to issue the commands.

In some other embodiments, at least one of the mobile nodes 110 can have the audio input device described above with reference to FIG. 3 for capturing on-site audio signals. Any one of the mobile nodes 110 can have the audio input device, regardless of whether the mobile node 110 has a capacity of issuing the control commands.

Although shown and described as being three aerial nodes 110A, 110B and 110C for purposes of illustration only, the system 100 can employ any suitable type and/or number of mobile nodes 110 for capturing pictures from different perspectives of the scene 125. In some embodiments, at least one of the mobile nodes 110 can be an aerial node for capturing the scene 125 from an elevation.

FIG. 6 illustrates another exemplary alternative embodiment of the system 100, wherein the terminal node 510 includes a microphone 610 and a mixer 710 for capturing audio signals for captured pictures. As shown in FIG. 6, the terminal node 510 can receive the first bitstream 111, unpack the first bitstream 111 to restore the captured pictures, process the pictures and repack the pictures into a second bitstream 222. The second bitstream 222 can be transmitted to a video server 810 (shown in FIG. 9) via the Internet 808 (shown in FIG. 1).

In FIG. 6, the terminal node 510 can be a computing device of any type, including but not limited to, a desktop, a laptop, a tablet, a touchpad, notepad, smartphone and any other types of computing devices and the like. The terminal node 510 can have a second processor 518 that can be internal and/or external to the terminal node 510. The second processor 518 can be associated with the microphone 610 and/or the mixer 710. In some embodiments, the second processor 518 can unpack the first bitstream 111 to restore the pictures captured by the imaging device 210 (shown in FIG. 3). The captured pictures can be displayed on one or more optional displays 612 of the terminal node 510.

The displays 612 can be associated with the second processor 518 and can be attached to or placed in proximity of the terminal node 510. The pictures, captured by the one or more aerial nodes 110, can be displayed on the respective displays 612 for facilitating processing of the pictures. The processing can include, but is not limited to, improving a quality of the pictures and/or mixing other data with the pictures. The other data can include, but is not limited to, video data, audio data and/or caption data. The other data can be either captured with any nodes described herein or with any other devices for capturing video data, audio data and/or textual data. The audio data can include, but is not limited to, comments and/or instructions to the pictures. In an exemplary embodiment, the pictures captured by the one or more mobile nodes 110 (not shown) can be merged to generate a combined video clip.

Without limitation, the second processor 518 can comprise any commercially-available graphic processor. The second processor 518, for example, can be a custom-designed graphic chips specially produced for the terminal node 510. Additionally and/or alternatively, the second processor 518 can include one or more general purpose microprocessors (for example, single or multi-core processors), application-specific integrated circuits, application-specific instruction-set processors, graphics processing units, physics processing units, digital signal processing units, coprocessors, network processing units, audio processing units, encryption processing units, and the like. The second processor 518 can be configured to perform any of the functions described herein, including but not limited to, a variety of operations relating to image processing. In some embodiments, the second processor 518 can include specialized hardware for processing specific operations relating to image processing.

The microphone 610 can be operably associated with the mixer 710. The microphone 610 can be any commercially-available microphones, including any type of device that can be used to capture audio signals. The microphone 610 can convert audio signals into electric data that is transmitted to the mixer 710. With the microphone 610, a user, e.g. a commentator, can record his/her voice while watching the captured pictures on the display 612 while the first bitstream 111 is being unpacked and displayed. Since the captured pictures can be displayed while the first bitstream 111 being unpacked, the user can give comments and/or instructions regarding the captured pictures in a real-time manner. Although shown and described as using the microphone 610 for purposes of illustration only, any other suitable audio input device 610 can be used for capturing the audio signals.

The mixer 710 can take the audio data captured by the microphone 610 and merge the audio data with the pictures unpacked by the second processor 518. In some embodiments, the mixer 710 can merge the pictures captured by different mobile nodes 110, e.g. the three mobile nodes 110A, 110B, 110C (shown in FIG. 5) in a synchronized manner. In other embodiments, the mixer 710 can merge audio data captured by at least one of the mobile nodes 110 with the captured pictures in a synchronized manner. Although shown and described as using one microphone 610 and one mixer 710 for purposes of illustration only, more than one microphone 610 and/or mixer 710 can be associated with the second processor 518 for merging audio data to the pictures. The second processor 518 can stream and/or segment the processed pictures into a second bitstream 222 that can be sent to one or more video servers 810 (show in FIG. 1).

Although shown and described as being contained in the terminal node 510 for purposes of illustration only, the microphone 610 and/or the mixer 710 can be external to terminal node 510 and be associated to the terminal node 510 for capturing and merging the audio data with the pictures.

FIG. 7 illustrates another exemplary alternative embodiment of the method 200, wherein captured pictures are received by the terminal node 510 and merged with the audio data. In FIG. 7, the terminal node 510 receives the first bitstream 111, at 550, from the mobile node 110 (shown in FIG. 3) via a connection 310 (shown in FIG. 6). The connection can be a wired and/or a wireless connection.

The first bitstream 111 can be packed in a proprietary protocol as shown and described with reference to FIG. 6. The first bitstream 111 can be unpacked, at 552, to restore the captured pictures that can be displayed, at 553, while being received. A viewer (not shown), e.g. a commentator, can watch the displayed pictures and provide comments on the pictures. In some other embodiments, an operator (not shown) can coordinate the mobile nodes 110 in cases of multiple mobile nodes 110 are employed. As shown and described with reference to FIG. 6, a plurality of displays 612 can be employed to facilitate the coordination among the multiple mobile nodes 110.

At 560, audio data can be acquired from an audio device, such as a microphone 610. The audio data can include, but is not limited to, commentary and/or dubbing voice. The audio data can be mixed with the unpacked pictures, at 570. The terminal node 510 can mix the audio data with the pictures with a mixer 710. In an embodiment, the audio data can be recorded and merged while repacking the pictures, at 580. The repacking of the pictures can be conducted in accordance with a second protocol. The second protocol can comprise any suitable conventional protocol that can be the same as, or different from, the first protocol. In one embodiment, the second protocol can be a protocol accepted by a video server 810, including, but not limited to, a video server 810, e.g. YouTube® and YouKu®.

The terminal node 510 can transfer the second bitstream via the Internet 808 to the video server 810, at 590. As an exemplary embodiment, a plurality of video servers 810 can receive the second bitstream 222 at a same time. For purposes of illustration, and not limitation, the pictures can be repacked into a plurality of second bitstream 222, each being streamed and/or segmented in accordance with a separate protocol acceptable to a respective video server 810.

FIG. 8 illustrates another exemplary alternative embodiment of the system 100, wherein the terminal node 510 includes a control node 618 for controlling the one or more mobile nodes 110 (shown in FIGS. 4 and 5). In FIG. 8, as shown and described with reference to FIG. 6, the terminal node 510 can have the second processor 518 that can be associated with the displays 612. The first bitstream 111 can be received by the terminal node 510 and be unpacked to restore the captured pictures that can be displayed on the displays 612.

As shown and described with reference to FIG. 5, one or more mobile nodes 110 can be employed for capturing pictures from different perspectives. In order to capture complete perspectives of a scene, the control node 618 can be configured to control the mobile nodes 110 in a coordinative manner. The control node 618 can be used to capture instructions for controlling the mobile nodes 618 and can pass the instructions to second processor 518. The second processor 518 can transfer the instructions, via the second connection (shown in FIG. 1), to the mobile nodes 618 for performing actions shown and described with reference to FIG. 5. The control node 618 can be a specialized device designed to control the mobile nodes 110 or it can be a general purpose computer of any type, a tablet, a smartphone or the like. The control node 618 can be separately disposed, connect with the terminal node 510, e.g. via the second processor 518, or connect with any other device.

Although shown and described as using one control node 618 from the terminal node 510 for purposes of illustration, any number of control nodes 618, in any locations, can be employed for coordinating the one or more mobile terminals from any suitable locations.

FIG. 9 illustrates another alternative exemplary embodiment of the method 200, wherein the mobile nodes 110 are coordinated from a control node 618. In FIG. 9, the one or more mobile nodes 110 are coordinated, at 168, for capturing pictures from different perspectives, at 160. Coordination of the one or more mobile nodes 110, by a user (not shown), can be conducted from the control node 618 (shown in FIG. 8) integrated with or separated from the terminal node 510. As shown and described with reference to FIG. 8, the pictures can be shown on one or more respective displays 612. The user can, for example, coordinate the mobile nodes 110 while watching the displays 612.

The coordination of the mobile nodes 110 can include controlling at least one of the mobile platforms 118 and the imaging device 210 for each of the mobile nodes 110 (collectively shown in FIG. 3). In some embodiments, the user can control the mobile platform 118 to change an elevation by ascending or descending, or to change an orientation by making turns. The user can also control one of the imaging devices 210 to change an orientation angle and/or a tilt angle via controlling a gimbal (not shown) that the imaging device 210 is attached. In some embodiments, the user can also control zoom-in and/or zoom-out actions of each of the imaging devices 210. Via the coordination of the mobile nodes 110, the scene 125 (shown in FIG. 3) can be captured from different perspectives and/or in its entirety.

The user can control the one or more imaging devices 210 via one centralized control node 618 and/or via a plurality of distributed control nodes 618 (not shown). The one or more control nodes 618 can be a portion of, or connected with, the terminal node 510. The control nodes 618 can connect with the terminal node 510 and/or the mobile node 110 with wired or wireless connections. The control nodes 618 can be any type of device that can send control signals to the mobile nodes 110, including, but not limited to, a desktop, a laptop, a tablet and a smartphone and the like.

Although shown and described as being with coordinating the one or more mobile nodes 110 after the capturing the pictures from the mobile nodes 110, the coordinating can be conducted at any time before and/or while capturing the pictures.

FIG. 10 illustrates another exemplary alternative embodiment of the system 100, wherein a video server 810 connects to a plurality of client receivers 910. In FIG. 10, the video server 810 can be a public video server including, but are not limited to, any one of commercially-available video sharing servers. Certain exemplary video servers 810 can include, but are not limited to, YouTube®, Vimeo®, Veoh®, Flickr® and YouKu® and the like. Captured pictures uploaded onto the video server 810 can be packed to a bitstream in accordance to a protocol that is acceptable to the client receivers 910.

The client receivers 910 can comprise any device that can have access to the Internet 808, including, but not limited to, a desktop, laptop, tablet and other handheld devices, e.g. smart phone. In some embodiments, the client receivers 910 can serve as a control node 618. A user can issue a command, directed to a mobile node 110, to the terminal node 510 via the video server 810. The terminal node 510 can pass the command to the respective mobile node 110.

FIG. 11 illustrates another exemplary alternative embodiment of the method 200, wherein a second bitstream 222 of captured pictures is made accessible from a video server 810. In FIG. 11, the second bitstream 222 can be received from the Internet 808 (shown in FIG. 12), at 812. The second bitstream 222, as described with reference to FIG. 12, can be packed in a protocol that is a defined by the video server 810 and can be viewed by client receivers 910 (shown in FIG. 10).

At 816, the second bitstream 222 can be made accessible, via the Internet 808, to the client receivers 910. Each of the client receivers 910 can connect to the video server 810 and be authenticated and/or authorized when each of the client receivers 910 selects to access the second bitstream 222.

FIG. 12 illustrates another exemplary alternative embodiment of the system 100, wherein the captured pictures are transferred to a video server 810 via a terminal node 510. In FIG. 12, as shown and described with reference to FIG. 3, the mobile node 110 can consist of the imaging device 210 for capturing pictures and the first processor 218 for processing the pictures.

The captured pictures can be video reflecting real-time views of a scene 125 (shown in FIG. 3) and can be streamed and/or segmented by the first processor 218 to generate the first bitstream 111 (shown in FIG. 3). The first bitstream 111 can be transferred to a terminal node 510. To facilitate the transfer, the pictures can be packed in accordance with a first protocol agreed by both the mobile node 110 and the terminal node 510. The first protocol can be a proprietary one, e.g. H.264, to ensure the transmission in a secure manner. Additionally or alternatively, the first processor 218 can further encode the streamed pictures to provide further security and/or compression for reducing a data amount for better transmission efficiency.

FIG. 12 shows a first connection 310 being provided for transmitting the first bitstream 111 from the mobile node 110 to the terminal node 510. The connection 310 can be a wired or wireless connection that can have a capacity to transmit the first bitstream 111 in a real-time manner while the pictures are being captured and the first bitstream 111 being generated. In some embodiments, the transmission speed of the connection can have a higher rate than a generation rate of the first bitstream 111 to ensure a real-time transmission of the pictures captured by the imaging device 210.

In FIG. 12, the terminal node 510 can receive the first bitstream 111 of captured pictures via the first connection 310. As shown and described with reference to FIG. 6, the terminal node 510 can be a mobile device that can have a second processor 518. The second processor 518 can operably connect with a display 612 and a mixer 710 that can be associated with a microphone 610. The second processor 518, while receiving the first bitstream 111, can unpack the first bitstream 111 to restore the pictures that can be shown on the display 612.

The microphone 610 can capture sound signal and convert the audio signal into electrical data. The electrical data can be transmitted to the mixer 710 and then merged with the pictures. The audio signal can represent comments and/or explanations to the pictures. A user can, for example, commentate on the pictures while watching the pictures on the display 612. The commentating voice can be converted into electrical signal and mixed, via the mixer 710, with the captured pictures in a synchronized manner.

In FIG. 12, the unpacked pictures can also be processed. Such process can include, but is not limited to, improving a quality of the picture and/or editing the pictures. The display 612 can be used to facilitate such processes.

The second processor 518 can stream and/or segment the pictures into a second bitstream 222 (shown in FIG. 6) in accordance with a second protocol. The second bitstream 222 can reflect the quality improvement and/or editing result. The second protocol can be a protocol agreed by the video server 810 (shown in FIG. 4). The second protocol can comprise a network control protocol, including but not limited to, a Real Time Messaging Protocol (“RTMP”) and a Real Time Streaming Protocol (“RTSP”). The video server 810 is shown and described for purposes of illustration only. In some embodiments, the captured pictures can be uploaded to a plurality of video servers 810. Because each video server 810 can agree with a different protocol, each second bitstream 222 can be streamed and/or segments in the different protocol.

The terminal node 510 can have a connection 807 to the Internet 808, which can be a wired or a wireless connection. A video server 810 can receive the second bitstream 222 from the Internet 808 via an Internet connection 809. The second bitstream can be accessible to one or more client receivers 910 that have Internet access. In some embodiments, the second bitstream can be unpacked to facilitate the accessibility of the one or more client receivers 910.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives.

What is claimed is:

1. A system for video broadcasting comprising:
a plurality of mobile nodes configured to capture one or more pictures and exchange control signals among the plurality of mobile nodes; and
a terminal node configured to receive the one or more pictures from the plurality of mobile nodes and upload the one or more pictures to a video server.

2. The system of claim 1, wherein each of the plurality of mobile nodes is associated with a respective mobile platform.

3. The system of claim 1, further comprising:
a control node configured to coordinate the plurality of mobile nodes and/or the terminal node, the control node being associated with at least one of the plurality of mobile nodes or the terminal node.

4. The system of claim 1, wherein the terminal node is associated with a ground node or an aerial node.

5. The system of claim 1, wherein:
the plurality of mobile nodes are further configured to transmit the one or more pictures to the terminal node as one or more first bitstreams via one or more datalinks, and
the terminal node is further configured to upload the one or more pictures to the video server as a second bitstream for broadcasting the one or more pictures at the video server.

6. The system of claim 5, wherein:
the plurality of mobile nodes are further configured to encode the one or more pictures in accordance with a private protocol to generate the one or more first bitstreams, and
the terminal node is further configured to pack the one or more pictures in accordance with a public protocol to generate the second bitstream.

7. The system of claim 1, wherein at least one of the plurality of mobile nodes includes an unmanned aerial vehicle and the terminal node includes a mobile device.

8. The system of claim 1, wherein the terminal node comprises an audio device configured to capture an audio signal.

9. The system of claim 8, wherein the terminal node further comprises an audio mixer configured to merge the audio signal with the one or more pictures.

10. The system of claim 1, wherein the plurality of mobile nodes capture the one or more pictures from a plurality of view-angles and/or elevations.

11. A method for video broadcasting comprising:
receiving, by a terminal node, one or more pictures captured by a plurality of mobile nodes that exchange control signals among plurality of mobile nodes; and
uploading, by the terminal node, the one or more pictures to a video server.

12. The method of claim 11, wherein receiving the one or more pictures comprises receiving the one or more pictures captured by the plurality of mobile nodes each associated with a respective mobile platform.

13. The method of claim 11, further comprising:
coordinating the plurality of mobile nodes and/or the terminal node with a control node associated with at least one of the plurality of mobile nodes or the terminal node.

14. The method of claim 11, further comprising:
enabling at least one of the terminal node or a client receiver that accesses the video server to control the plurality of mobile nodes.

15. The method of claim 11, wherein:
receiving the one or more pictures includes receiving the one or more pictures as one or more first bitstreams via one or more datalinks, and
uploading the one or more pictures includes uploading the one or more pictures as a second bitstream for broadcasting the one or more pictures at the video server.

16. The method of claim 11, further comprising:
encoding the one or more pictures by the plurality of mobile nodes in accordance with a private protocol to generate the one or more first streams, and
packing the one or more pictures by the terminal node in accordance with a public protocol to generate the second bitstream.

17. The method of claim 11, wherein at least one of the plurality of mobile nodes includes an unmanned aerial vehicle and the terminal node includes a mobile device.

18. The method of claim 11, further comprising:
capturing audio data via an audio device of the terminal node.

19. The method of claim 18, further comprising:
merging the audio data with the one or more pictures.

20. The method of claim 11, wherein receiving the one or more pictures includes receiving the one or more pictures captured from a plurality of view-angles and/or elevations.
